(19) United States
(12) Patent Application Publication
(10) Pub. No.: US 2021/0096513 A1
(43) Pub. Date: Apr. 1, 2021

(54) TIMEPIECE MECHANISM

(71) Applicant: PATEK PHILIPPE SA GENEVE, Genève (CH)

(72) Inventors: James HIDE, Plan-Les-Ouates (CH); Stéphane OES, La Chaux-De-Fonds (CH); Frédéric MAIER, Neuchâtel (CH)

(21) Appl. No.: 16/603,735

(22) PCT Filed: Apr. 17, 2018
(86) PCT No.: PCT/IB2018/052644

§ 371 Date: Oct. 8, 2019

(30) Foreign Application Priority Data
Apr. 18, 2017 (EP) 17166832.0

(51) Int. Cl. G04B 15/10; G04B 1/12; G04B 17/04; G04B 19/243; G04B 19/253; G04B 19/26

(52) U.S. Cl. CPC G04B 15/10; G04B 1/12; G04B 19/268; G04B 19/2434; G04B 19/253; G04B 17/04

(57) ABSTRACT

A timepiece mechanism includes a first energy source with a regulating member, a second independent energy source, a control member driven by the second energy source, and a blocking device controlled by the first energy source to block the second energy source and release it to allow the control member to be displaced by jumps powered by the second energy source. The blocking device includes first and second mobile parts kinematically interconnected, the first mobile part including a drive device, the second mobile part including a stopping device; a rotating drive member connected to the first energy source and cooperating with the drive device to displace the mobile parts, alternately in opposite directions; and a rotating blocking member connected to the second energy source and cooperating with the stopping device to be blocked by the second mobile part and released at the determined times by second mobile part movement.

The present invention relates to a timepiece mechanism comprising:
a first source of energy,
a regulating member arranged to regulate the first source of energy,
a second source of energy independent of the first source of energy, a control member arranged to be driven by the second source of energy and to control for example a display, and
a blocking device arranged to be controlled by the first source of energy to block the second source of energy and to release it at determined times in order to allow the control member to be displaced by jumps under the action of the second source of energy.

Mechanisms of this type are described in documents CH 702354, CH 703797 and EP 1658531. The aim thereof is to suppress or attenuate the drawing of energy from the first source of energy for displaying one or more determined values so as to prevent this displaying action from disrupting the oscillations of the regulating member or decreasing the duration of operation of a gear train driven by the first source of energy.

In document CH 702354, the first source of energy is intended exclusively for maintaining the oscillations of the regulating member, i.e. does not drive any displaying device, whilst the second source of energy is used to drive displaying devices, i.e. in particular a jumping seconds hand and indicators for the time, date and phase of the moon.

In document CH 703797, the first source of energy drives a time display via a first gear train whilst the second source of energy drives, via a second gear train, indicators for chronograph seconds, minutes counter, hours counter and jumping seconds.

In these two documents CH 702354 and CH 703797, the blocking device is in the form of a wolf-tooth wheel which is coaxial with and fixedly attached to an escape wheel of the regulating member and which co-operates with a starwheel of a jumping seconds wheel assembly. The display(s) driven by the second source of energy are dragging displays and the proposed mechanism does not allow the instantaneous displaying of a value, in particular a value which varies infrequently, such as the date. Also, the starwheel of the jumping seconds wheel assembly exerts a force on the wolf-tooth wheel, and thus on the escape wheel, which can disrupt the oscillations of the regulating member.

In document EP 1658531, the second source of energy drives, via a second gear train, a display device comprising discs indicating hours and minutes of a chronograph, and the blocking device comprises a first lever and a second lever. The first lever is raised at times determined by a minutes wheel driven by the first source of energy via a first gear train to cause the second lever to pivot so that lifts borne by the second lever release a cam and a flywheel respectively. The cam and the flywheel thus start to turn under the action of the second source of energy which causes the indicating discs to turn. The blocking device according to this document is complicated and produces a great deal of friction, in particular between the minutes wheel and the first lever and between the second lever and the cam. Moreover, if the minutes wheel stops, in the event of a shock or time-setting for example, just after having raised the first lever, the wheel assemblies of the display device continue to turn under the action of the second source of energy, the second lever not being able to descend again to stop the cam and the flywheel. The display is thus deregulated.

The present invention aims to overcome, at least in part, the disadvantages stated above and is characterised in that the blocking device comprises:
first and second mobile parts kinematically connected to one another, the first mobile part comprising a drive device, the second mobile part comprising a stopping device,
a rotating drive member kinematically connected to the first source of energy and arranged to co-operate with the drive device to displace the first mobile part, and thus the second mobile part, alternately in opposite directions, and
a rotating blocking member kinematically connected to the second source of energy and arranged to co-operate with the stopping device to be blocked by the second mobile part and released at said determined times by said displacements of the second mobile part.

Other features and advantages of the present invention will become clear upon reading the following detailed description given with reference to the attached drawings in which:

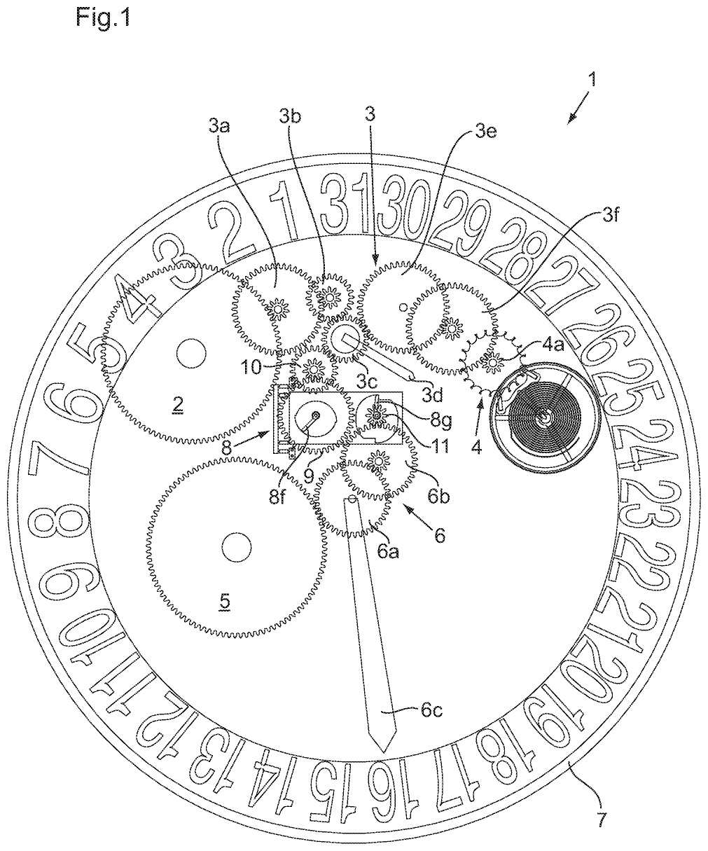

FIG. 1 is a top view of a timepiece mechanism in accordance with the invention;

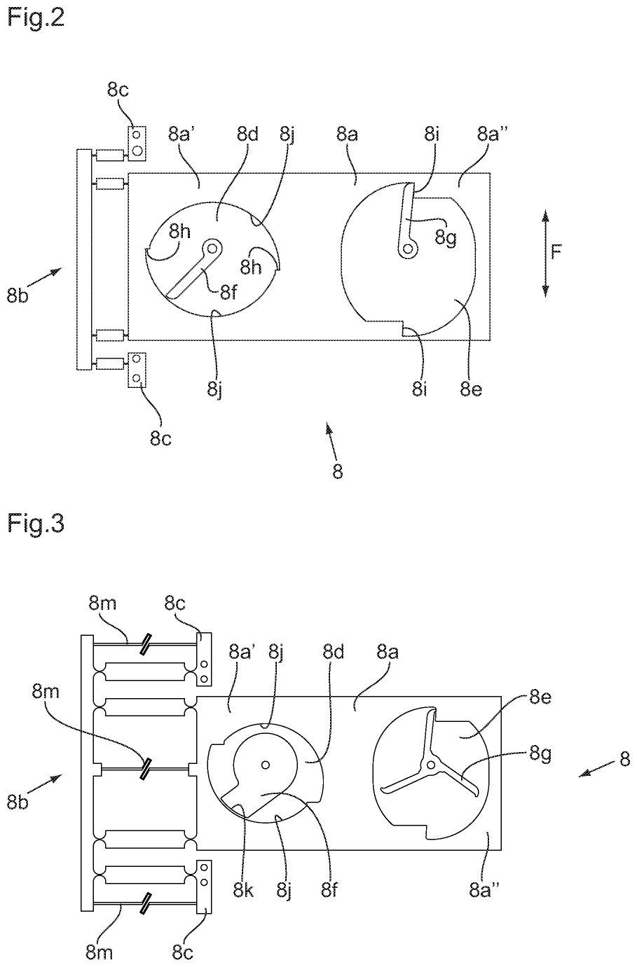

FIG. 2 shows the co-operation between a frame which can move in translation guided by a flexible guiding device, a drive member and a blocking member forming part of the timepiece mechanism in accordance with the invention; for reasons of simplification, the flexible guiding device is shown in this FIG. 2—as in FIGS. 3, 7, 8 and 9 discussed below—in a rest state whilst in practice it is deformed;

FIG. 3 shows the co-operation between a frame which can move in translation guided by a flexible guiding device, a drive member and a blocking member in accordance with one variant of the invention;

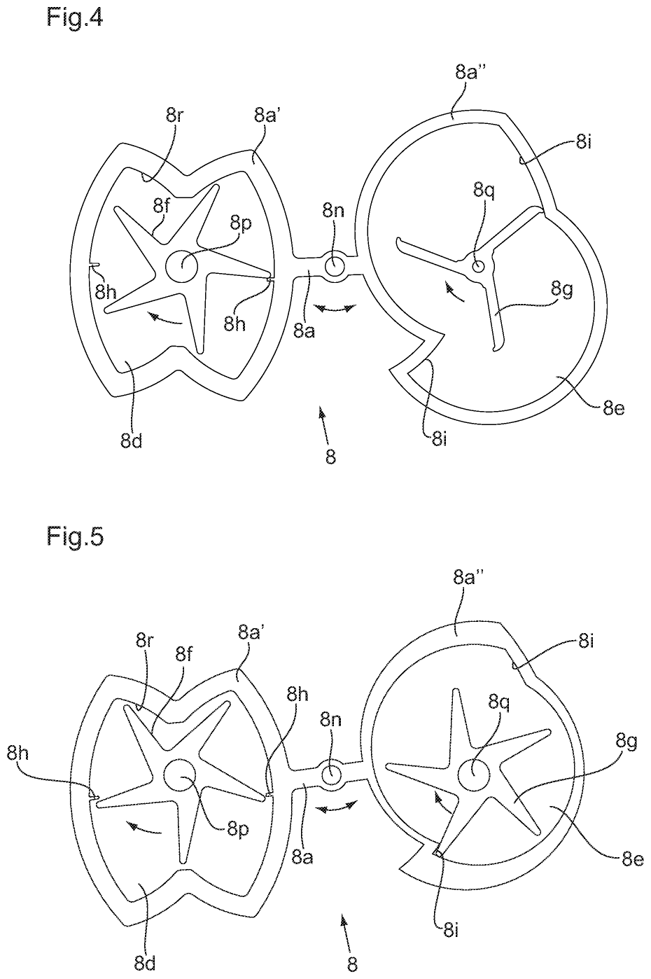

FIG. 4 shows the co-operation between a frame which can move in rotation, a drive member and a blocking member in accordance with another variant of the invention;

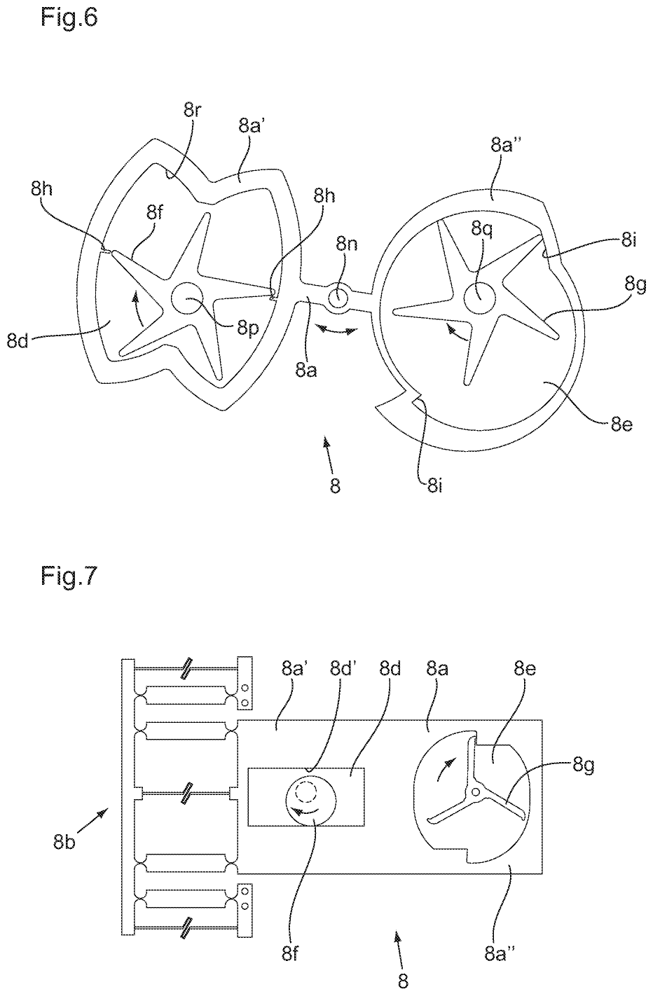

FIGS. 5 and 6 show the co-operation between a frame which can move in rotation, a drive member and a blocking member in accordance with yet another variant of the invention, with the mobile frame being in two different blocking positions;

FIG. 7 shows the co-operation between a frame which can move in translation guided by a flexible guiding device, a drive member and a blocking member in accordance with yet another variant of the invention;

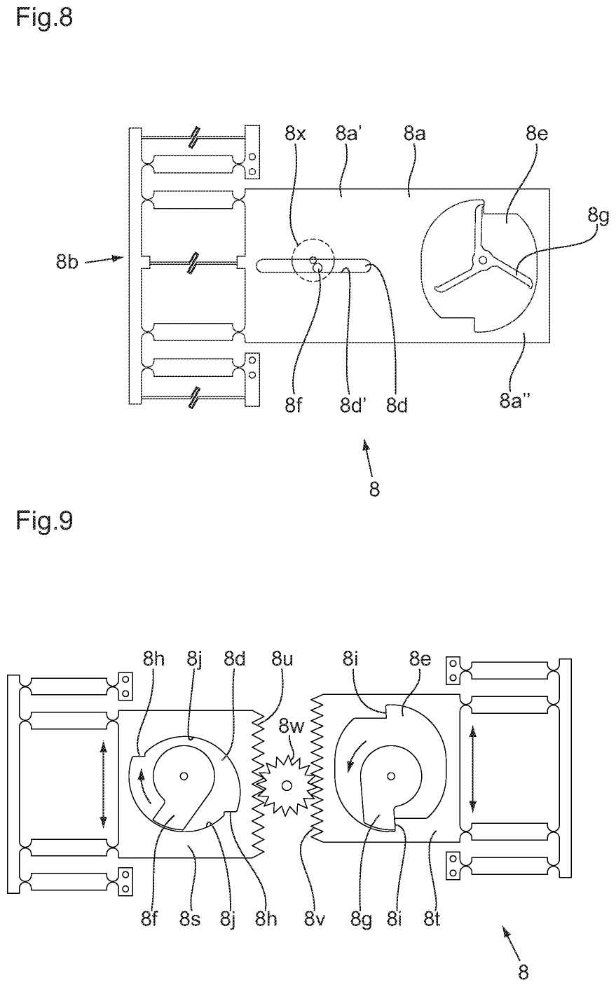

FIG. 8 shows the co-operation between a frame which can move in translation guided by a flexible guiding device, a drive member and a blocking member in accordance with yet another variant of the invention; and

FIG. 9 shows the co-operation between two frames which can move in translation, a drive member and a blocking member in accordance with yet another variant of the invention.

With reference to FIG. 1, a timepiece mechanism 1 in accordance with the invention, for a timepiece such as a wristwatch or a pocket watch, comprises a first source of energy 2, a first gear train 3 and a regulating member 4. Typically, the first source of energy 2 is in the form of a barrel housing a mainspring and the regulating member 4 comprises a balance-hairspring and an escapement. In a conventional manner, the first source of energy 2 can be wound by the user using a manual winding mechanism and/or by an automatic winding mechanism (with oscillating mass). The first gear train 3 is a going gear train successively comprising, in the illustrated example, a great wheel-and-pinion assembly 3a, a third wheel-and-pinion assembly 3b, an hour wheel 3c carrying an hour-indicating hand 3d, an intermediate wheel 3e and a fourth wheel-and-pinion assembly 3f. The great wheel-and-pinion assembly 3a meshes with the barrel 2 whilst the fourth wheel-and-pinion assembly 3f meshes with an escapement pinion 4a of the regulating member 4.

The timepiece mechanism 1 further comprises a second source of energy 5 and a second gear train 6. Like the first source of energy 2, the second source of energy 5 is typically in the form of a barrel housing a mainspring. The first and second sources of energy 2, 5 are independent in the sense that neither of them provide energy to the other. In the illustrated example, the second gear train 6 comprises a date wheel 6a which meshes with the barrel 5 and a reducer wheel-and-pinion assembly 6b which meshes with the date wheel 6a. The date wheel 6a carries a date-indicating hand 6c directed towards a date scale 7 provided on a dial of the timepiece mechanism 1. However, as a variant, the indicating hand 6c could be replaced by one or more indicating discs co-operating with one or more apertures in the dial. The date wheel 6a is a control member in the sense of the present invention.

The timepiece mechanism 1 also comprises a blocking device 8 for blocking and releasing the second gear train 6 under the control of the first gear train 3. This blocking device 8 comprises (cf. FIGS. 1 and 2) a mobile frame 8a which is guided in translation along the double arrow F by a flexible guiding device 8b. The flexible guiding device 8b is known per se. It is formed of a set of rigid parts and elastic parts, the set being fixed by two 8c of its rigid parts to the framework of the timepiece mechanism 1 and joined to the mobile frame 8a. Preferably, the flexible guiding device 8b forms a monolithic piece with the mobile frame 8a. The flexible guiding device 8b as shown is designed to eliminate the stray translational and rotational movements such that the mobile frame 8a moves purely in a translational manner. However, the present invention does not exclude the use of a simpler flexible guiding device, e.g. allowing a slight rotational displacement in addition to the translational displacement.

The mobile frame 8a has two openings 8d, 8e, the respective contours of which are closed. The first opening 8d receives a drive member 8f in the form of a finger which is coaxial with and fixed relative to a wheel 9 which meshes with the first gear train 3 via a reducer wheel-and-pinion assembly 10. The second opening 8e receives a blocking member 8g in the form of a finger which is coaxial with, and fixed relative to, a pinion 11 which meshes with the reducer wheel-and-pinion assembly 6b of the second gear train 6.

Two diametrically opposed offsets 8h in the wall of the first opening 8d form drive elements. Two diametrically opposed offsets 8i in the wall of the second opening 8e form stopping elements. Except at midnight, the blocking member 8g, which is tensioned by way of the torque exerted by the second source of energy 5, remains in abutment against one of the stopping elements 8i, which keeps the second source of energy 5, the second gear train 6 and the date-indicating hand 6c stationary. The drive member 8f is continuously driven by the first gear train 3 in the clockwise direction in FIGS. 1 and 2 at a rate of one revolution every 48 hours. Once every 24 hours, the drive member 8f contacts one of the drive elements 8h and then co-operates with it tangentially (in the manner of a gear) to displace the mobile frame 8a in translation during a time interval, e.g. one to two hours, overlapping midnight. At midnight, the displacement of the mobile frame 8a releases the blocking member 8g which loses the contact with the stopping element 8i on which it was in abutment. The second source of energy 5 is thus no longer held and the assembly 5, 6, 8g, 11 starts to turn until the blocking member 8g comes to abut against the other stopping element 8i and once again block the second source of energy 5 and the second gear train 6, a position in which the date-indicating hand 6c indicates the next date. The drive member 8f then leaves the drive element 8h with which it co-operated and continues its rotation without driving or touching the mobile frame 8a, the latter being immobilised by a slight draw exerted by the blocking member 8g on the stopping element 8i against which it bears—for this purpose the stopping elements 8i are slightly inclined—this draw compensating for the elastic return force exerted by the flexible guiding device 8b on the mobile frame 8a and being able to cause the wall of the second opening 8e to abut against the blocking member 8g as shown in FIG. 2. Then, approaching the following midnight, the drive member 8f contacts the other drive element 8h to displace the mobile frame 8a in translation in the other direction during a time interval overlapping midnight. At midnight, the displacement of the mobile frame 8a releases the assembly 5, 6, 8g, 11 which starts to turn, causing the date-indicating hand 6c to jump, until the blocking member 8g again abuts against the first stopping element 8i. The drive member 8f then leaves the drive element 8h with which it was in contact and continues its rotation without driving or touching the mobile frame 8a which is immobilised by the draw exerted by the blocking member 8g. Then, the cycle is repeated.

The displaying of the date is thus instantaneous and the energy which powers it is provided exclusively by the second source of energy 5, allowing the assembly formed by the first source of energy 2—first gear train 3—regulating member 4 to retain its duration of run and to not be disrupted by the displaying of the date. Moreover, friction is low because in normal operation the drive member 8f is in contact with the wall of the first opening 8d only when it co-operates with the drive elements 8h, i.e. in a cumulative manner over less than 60%, or even less than 50%, or even less than 40%, or even less than 30%, or even less than 20% of one revolution of the drive member 8f. In the example illustrated in FIG. 2, the contact between the drive member 8f and the drive elements 8h occurs only over about 16% (about 8% per drive element 8h) of one revolution of the drive member 8f. Furthermore, even in the event of a shock or time-setting stopping the first gear train 3, the position of the indicating hand 6c is secured by the abutment of the blocking member 8g on one of the stopping elements 8i.

The second source of energy 5 can have its own winding mechanism which can be actuated from outside the timepiece. Given that it is used only once per day, the second source of energy 5 also may not have a winding mechanism and can be wound only during regular maintenance of the watch, i.e. for example every five years. The use of a standard-sized barrel, or even a smaller-sized barrel, as the second source of energy 5 is sufficient to obtain a duration of run of several years, longer than the service interval.

This latter solution, i.e. with no winding mechanism which can be actuated by the user for the second source of energy 5, is preferred in the present invention. Indeed, it does not require the provision of a link between the second source of energy 5 and the exterior of the timepiece, a link which would impair the sealing tightness of the timepiece. It also does not require the second source of energy 5 to be mechanically connected to the winding mechanism of the first source of energy 2 and thus considerably simplifies the timepiece mechanism 1. Moreover, it avoids using the automatic winding mechanism of the first source of energy 2, when such an automatic winding mechanism is provided, and thus does not require the size of the oscillating mass to be increased. A still further advantage is that the second source of energy 5 can be placed much more freely in the timepiece mechanism 1, since it does not need to be in proximity to the winding mechanism of the first source of energy 2.

As shown in FIG. 2, the wall of the first opening 8d comprises two opposing circular arc parts 8j which have the same radius but different centres, the two junctions between these two parts 8j forming the drive elements 8h. The radius of the two circular arc parts 8j is slightly greater than the radius of the circle travelled by the end of the drive member 8f. Each circular arc part 8j, when the drive member 8f moves in front of it, has its centre which coincides with the centre of rotation of the drive member 8f. In this manner, during its rotation between the two drive elements 8h, the end of the drive member 8f follows the wall of the first opening 8d, thus protecting the blocking device 8 from shocks. Indeed, in the event of a shock received by the timepiece mechanism 1 which would tend to displace the mobile frame 8a in the direction (upwards in the configuration of FIGS. 1 and 2) which is unfavourable in terms of the blocking of the blocking member 8g, the wall of the first opening 8d immediately abuts against the end of the drive member 8f, which prevents release of the blocking member 8g. The position of the date-indicating hand 6c is thus secured.

The drive 8f and blocking 8g members can each have several fingers or teeth. By way of example, FIG. 3 shows one variant of the invention in which the blocking member 8g is in the form of a starwheel with three teeth. Moreover, as shown in this FIG. 3, the drive member 8f can be a relatively wide finger and its end 8k can be a circular arc centred on the centre of rotation of the drive member 8f and with a radius slightly smaller than the radius of the circular arc parts 8j of the wall of the first opening 8d. In the event of a shock received by the timepiece mechanism 1 which would tend to displace the mobile frame 8a in a direction which is unfavourable in terms of the blocking of the blocking member 8g, the wall of the first opening 8d immediately abuts against the drive member 8f, thereby preventing release of the blocking member 8g.

As also shown in FIG. 3, the blocking device 8 can comprise tension springs 8m (shown schematically) arranged to totally or partially compensate for the return force exerted by the flexible guiding device 8b. The mobile frame 8a is thus subjected to a zero return force or a weaker return force during its translational displacements.

It goes without saying that, as an alternative to the flexible guiding device 8b, the mobile frame 8a could be mounted in a slidable manner.

In the two latter cases mentioned above, where no elastic return force is exerted on the mobile frame 8a, the drawing force applied by the blocking member 8g upon its contact with the stopping element 8i displaces the mobile frame 8a until the wall of the second opening 8e abuts against the blocking member 8g, thereby immobilising the mobile frame 8a.

In all the cases described above, the application of a drawing force to the mobile frame 8a is advantageous for minimising friction. However, the invention does not exclude the possibility of operating the blocking device 8 without a drawing force, in particular in the cases where no elastic return force is exerted on the mobile frame 8a.

FIG. 4 shows another variant of the invention in which the mobile frame 8a is mounted to rotate about an axis 8n separate from the rotational axes 8p, 8q of the drive 8f and blocking 8g members. The drive 8f and blocking 8g members are here in the form of starwheels but they could also be simple fingers. The stopping elements 8i defined by the wall of the second opening 8e are circular arcs centred on the geometrical rotational axis of the mobile frame 8a, such that the bearing force exerted by the blocking member 8g on the mobile frame 8a is located on a straight line intersecting said geometrical rotational axis. In this manner, the fact that the blocking member 8g bears against the mobile frame 8a does not cause displacement of the latter. Nevertheless, as a variant, it is possible to incline the stopping elements 8i such that the blocking member 8g exerts on the mobile frame 8a a draw which immobilises the mobile frame 8a by compensating for possible elastic return torque applied to the mobile frame 8a and/or by causing the wall of the second opening 8e to bear against the blocking member 8g, as shown in FIGS. 5 and 6 for the two stopping elements 8i.

Referring to FIGS. 4 to 6, the wall 8r of the first opening 8d which receives the drive member 8f comprises two protrusions forming the drive elements 8h and is shaped to follow, over substantially 360°, the path of the tip of the finger or of a tooth of the drive member 8f in a coordinate system linked to the mobile frame 8a during rotation of the drive member 8f. This shape of the wall 8r of the first opening 8d allows the mobile frame 8a to abut immediately against the drive member 8f in the event of a shock in any direction and to thereby secure the blocking of the blocking member 8g. In the exemplified embodiments in FIGS. 1 to 3, the wall of the first opening 8d, with its circular arc parts 8j, is also shaped to follow, over substantially 360°, the path of the tip of the finger or of a tooth of the drive member 8f in a coordinate system linked to the mobile frame 8a during rotation of the drive member 8f.

FIG. 7 shows yet another variant of the invention in which the drive member 8f is no longer in the form of a finger or a starwheel but in the form of an eccentric disc frictionally co-operating with the wall 8d′ of the opening 8d. This disc 8f causes the mobile frame 8a to move reciprocally in translation, guided by the flexible guiding device 8b. The wall 8d′ can have a rectangular shape, as shown, or another shape such as an ellipse.

In yet another variant, shown in FIG. 8, the drive member 8f is a pin carried by a disc or wheel 8x and engaged in the first opening 8d of the mobile frame 8a, an opening which here is oblong in shape. By way of friction with the wall 8d′ of the first opening 8d, the pin 8f causes the mobile frame 8a to move reciprocally in translation, guided by the flexible guiding device 8b.

FIG. 9 shows yet another variant of the invention in which the mobile frame 8a is replaced by two frames 8s, 8t which can move with respect to the framework of the timepiece mechanism 1 and can move with respect to each other. The first frame 8s comprises the first opening 8d which receives the drive member 8f and the second frame 8t comprises the second opening 8e which receives the blocking member 8g. These frames 8s, 8t are for example guided by respective flexible guiding devices and are kinematically connected to one another. In the illustrated example, the frames 8s, 8t are movable in translation and comprise respective racks 8u, 8v which mesh with a starwheel 8w. In variants, the frames 8s, 8t, or only one of them, could be movable in rotation.

By analogy with the exemplified embodiment of FIG. 9, it can be considered that the mobile frame 8a of FIGS. 1 to 8 comprises first and second mobile frames or parts 8a′, 8a″, these mobile frames or parts 8a′, 8a″ respectively having first and second openings 8d, 8e and being fixed relative to one another, thus kinematically connected to one another, and more particularly forming part of the same monolithic piece.

Numerous configurations other than those shown in the figures and described above are possible in the present invention. For example, instead of being coplanar, the openings 8d, 8e could be superimposed. The openings 8d, 8e could also be replaced by arms bearing tips fulfilling the function of the drive elements 8h and the stopping elements 8i. Furthermore, more than two drive elements 8h and/or more than two stopping elements 8i could be provided. For example, the wall of the first opening 8d could define additional drive elements to allow pre-winding of the mobile frame 8a or of the part 8a′ prior to its displacement causing the release of the blocking member 8g.

The present invention is not limited to displaying the date. Indeed, it will be clear to a person skilled in the art that values or information other than the date can be displayed with the mechanism in accordance with the invention, such as the phase of the moon, the week, the day of the week or the month. The present invention can also be used not for displaying a value or information but for triggering a mechanism such as a striking mechanism.

1. Timepiece mechanism (1) comprising:
a first source of energy (2),
a regulating member (4) arranged to regulate the first source of energy (2),
a second source of energy (5) independent of the first source of energy (2),
a control member (6a) arranged to be driven by the second source of energy (5),
a blocking device (8) arranged to be controlled by the first source of energy (2) to block the second source of energy (5) and to release it at determined times in order to allow the control member (6a) to be displaced by jumps under the action of the second source of energy (5),
wherein the blocking device (8) comprises:
first and second mobile parts (8a′, 8a″; 8s, 8t) kinematically connected to one another, the first mobile part (8a′; 8s) comprising a drive device (8h; 8d′), the second mobile part (8a″; 8t) comprising a stopping device (8i),
a rotating drive member (8f) kinematically connected to the first source of energy (2) and arranged to co-operate with the drive device (8h; 8d′) to displace the first mobile part (8a′; 8s), and thus the second mobile part (8a″; 8t), alternately in opposite directions, and
a rotating blocking member (8g) kinematically connected to the second source of energy (5) and arranged to co-operate with the stopping device (8i) to be blocked by the second mobile part (8a″; 8t) and released at said determined times by said displacements of the second mobile part (8a″; 8t).

2. Timepiece mechanism as claimed in claim 1, wherein the first and second mobile parts (8a′, 8a″) are fixed relative to one another.

3. Timepiece mechanism as claimed in claim 2, wherein the first and second mobile parts (8a′, 8a″) form or are part of a same monolithic piece (8a).

4. Timepiece mechanism as claimed in claim 1, wherein the first and second mobile parts (8s, 8t) can move with respect to each other.

5. Timepiece mechanism as claimed in claim 1, wherein the stopping device (8i) is arranged such that the co-operation between the rotating blocking member (8g) and the stopping device (8i) immobilises the second mobile part (8a″; 8t) and thus the first mobile part (8a′; 8s) when the rotating drive member (8f) does not co-operate with the drive device (8h; 8d′).

6. Timepiece mechanism as claimed in claim 1, wherein during normal operation, the rotating drive member (8f) is in contact with the first mobile part (8a′; 8s) only when it co-operates with the drive device (8h), i.e. over less than 60% of one revolution of the rotating drive member (8f).

7. Timepiece mechanism as claimed in claim 1, wherein the first mobile part (8a′; 8s) has an opening (8d) with a closed contour receiving the rotating drive member (8f) and the wall of which defines the drive device (8h; 8d′).

8. Timepiece mechanism as claimed in claim 7, wherein the wall of the opening (8d) of the first mobile part (8a′; 8s) follows, over substantially 360°, the path of a tip of the rotating drive member (8f) in a coordinate system linked to the first mobile part (8a′; 8s) during rotation of the rotating drive member (8f) to protect the blocking device (8) from shocks.

9. Timepiece mechanism as claimed in claim 7, wherein the wall of the opening (8d) of the first mobile part (8a′; 8s) comprises two opposing circular arc parts (8j) which have the same radius but different centres, the junctions between these two circular arc parts (8j) forming the drive device (8h).

10. Timepiece mechanism as claimed in claim 1, wherein the rotating drive member (8f) is in the form of a finger or a starwheel.

11. Timepiece mechanism as claimed in claim 7, wherein the rotating drive member (8f) is in the form of an eccentric disc.

12. Timepiece mechanism as claimed in claim 7, wherein the rotating drive member (8f) is in the form of a pin.

13. Timepiece mechanism as claimed in claim 1, wherein the second mobile part (8a″; 8t) has an opening (8e) with a closed contour receiving the rotating blocking member (8g) and the wall of which defines the stopping device (8i).

14. Timepiece mechanism as claimed in claim 1, wherein the rotating blocking member (8g) is in the form of a finger or a starwheel.

15. Timepiece mechanism as claimed in claim 1, wherein the drive device (8h) comprises first and second drive elements.

16. Timepiece mechanism as claimed in claim 1, wherein the stopping device (8i) comprises first and second stopping elements.

17. Timepiece mechanism as claimed in claim 1, wherein the first and second mobile parts (8a′, 8a″; 8s, 8t) are each movable in translation.

18. Timepiece mechanism as claimed in claim 1, wherein the first and second mobile parts (8a′, 8a″) are each movable in rotation.

19. Timepiece mechanism as claimed in claim 1, wherein the first and second mobile parts (8a′, 8a″; 8s, 8t) are guided by one or more flexible guiding devices (8b).

20. Timepiece mechanism as claimed in claim 19, wherein the flexible guiding device(s) (8b) is/are arranged to allow displacement of the first and second mobile parts (8a′, 8a″; 8s, 8t) only in translation.

21. Timepiece mechanism as claimed in claim 1, wherein the control member (6a) is arranged to control an indication of the date, week, day of the week, month or phase of the moon, or to control a striking mechanism.

22. Timepiece mechanism as claimed in claim 1, wherein the second source of energy (5) is not associated with any winding mechanism which can be actuated by the user.
